(19) United States
(12) Patent Application Publication
(10) Pub. No.: US 2012/0255266 A1
(43) Pub. Date: Oct. 11, 2012

(54) INERTIAL FILTER FOR ENVIRONMENTAL CONTROL SYSTEM HEAT EXCHANGER APPLICATIONS

(75) Inventor: KADER FELLAGUE, HAMBURG (DE)

(73) Assignee: HONEYWELL INTERNATIONAL INC., MORRISTOWN, NJ (US)

(21) Appl. No.: 13/083,566

(22) Filed: Apr. 10, 2011

(51) Int. Cl. B01D 45/04

(52) U.S. Cl. 55/385.2; 55/442; 55/443; 55/434.2

(57) ABSTRACT

An inertial filter may allow longer cleaning intervals as compared to conventional filters. The inertial filter may be used with devices such as ozone converters or heat exchangers in aircraft applications. The inertial filter may be a louvered inertial filter adapted to change the direction of a large portion of inlet air, forcing this large portion through louvers as clean outlet air. A small portion of air is permitted to continue in its original direction, carrying with it dust and particles. The small portion of air may be up to about 10 percent of the total air flow through the filter.

### BACKGROUND OF THE INVENTION

The present invention relates to a filtration apparatus and, more particularly, to an inertial filter for environmental control system (ECS) heat exchanger applications.

ECS heat exchangers are required to deliver higher and higher performance in a more compact space in new air conditioning systems. This requirement translates in high density fin passages to meet heat transfer performance. The downside of this trend is that the high density fin passages are less permeable, on the hot air bleed side, to fine dust, sand, salt, pollution and the like. These contaminants tend to be ingested by the engines, auxiliary power units (APUs), or a ground cart, especially in ground operations in arid areas. These contaminants tend to accumulate in the core and downstream components, such as air cycle machines, which leads to higher system temperature by reducing heat exchanger efficiency (fouling), potential failure of devices such as bearings, and even aircraft delay (aircraft on the ground (AOG) time) and higher costs.

As can be seen, there is a need for a filtration system for filtering aircraft bleed air before the air passes through a heat exchanger or other downstream components.

### SUMMARY OF THE INVENTION

In one aspect of the present invention, an inertial filter for purifying an air flow comprises an air inlet adapted to receive the air flow; a plurality of louvers adapted to change a direction of a first air flow passing through the air inlet; and a second air flow passing through a central portion of the inertial filter with its flow direction unchanged by the louvers, wherein the first air flow contains less contaminants compared to the second air flow; and a diameter of the central portion of the inertial filter decreases from the air inlet to a central outlet of the inertial filter.

In another aspect of the present invention, an environmental control system heat exchanger comprises at least one heat exchanger air inlet; at least one heat exchanger air outlet; and an inertial filter installed within at least one of the at least one heat exchanger air inlet, the inertial filter includes an air inlet adapted to receive the air flow; a plurality of louvers adapted to change a direction of a first air flow passing through the air inlet; and a second air flow passing through a central portion of the inertial filter with its flow direction unchanged by the louvers, wherein the first air flow contains less contaminants compared to the second air flow; and a diameter of the central portion of the inertial filter decreases from the air inlet to a central outlet of the inertial filter.

In a further aspect of the present invention, a bleed air ozone converter comprises an air inlet adapted to deliver an air flow to an ozone converter; an air outlet adapted to receive the air flow from the ozone converter; and an inertial filter inside the air outlet, the inertial filter includes an inertial filter air inlet adapted to receive the air flow; a plurality of louvers adapted to change a direction of a first air flow passing through the inertial filter air inlet; and a second air flow passing through a central portion of the inertial filter with its flow direction unchanged by the louvers, wherein the first air flow contains less contaminants compared to the second air flow; and a diameter of the central portion of the inertial filter decreases from the inertial filter air inlet to a central outlet of the inertial filter.

These and other features, aspects and advantages of the present invention will become better understood with reference to the following drawings, description and claims.

### BRIEF DESCRIPTION OF THE DRAWINGS

FIG. 1 is a cross-sectional view of an inertial filter according to an exemplary embodiment of the present invention;

FIG. 1A is a perspective view of one louver from the inertial filter of FIG. 1;

FIG. 2 is a perspective view of a heat exchanger adapted to include the inertial filter of FIG. 1; and

FIG. 3 is a side view of an ozone converter with the inertial filter of FIG. 1 formed at an outlet thereof.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention provide an inertial filter that may allow longer cleaning intervals as compared to conventional filters. The inertial filter may be used with devices such as ozone converters or heat exchangers in aircraft applications. The inertial filter may be a louvered inertial filter adapted to change the direction of a large portion of inlet air, forcing this large portion through louvers as clean outlet air. A small portion of air is permitted to continue in its original direction, carrying with it dust and particles. In some embodiments, the small portion of scavenging air may be up to about 10 percent of the total air flow through the filter. Generally, contamination should be removed as far upstream of the system as allowed by the aircraft and system installation. Therefore, the inertial filter can be incorporated in the heat exchanger precooler that is normally part of ATA 36 and is usually housed in the pylon of the engine, when such installation permits. The inertial filter is typically installed at the inlet of the equipment be it heat exchanger or ozone converter.

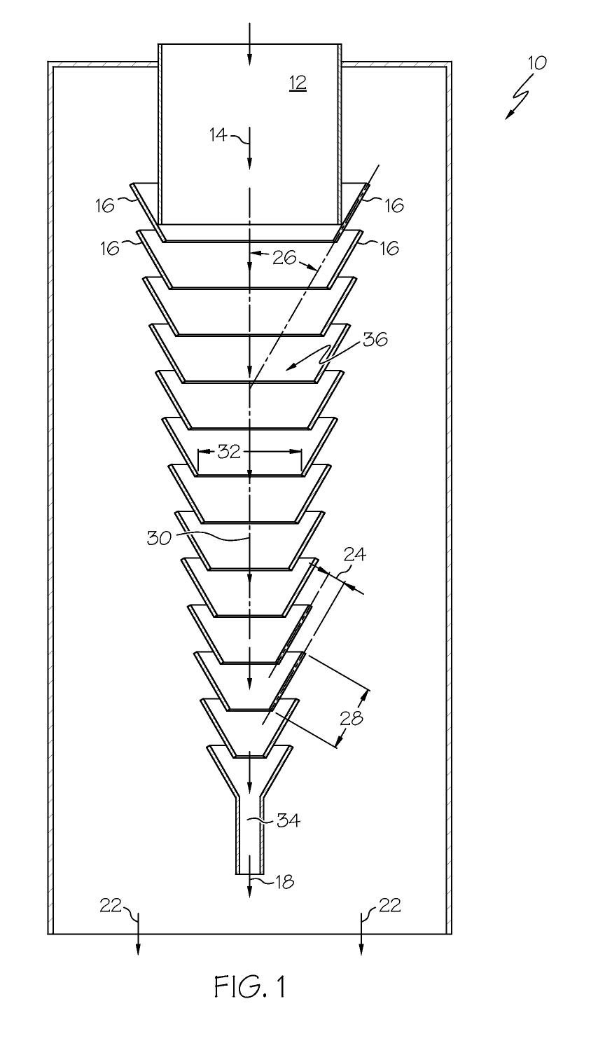

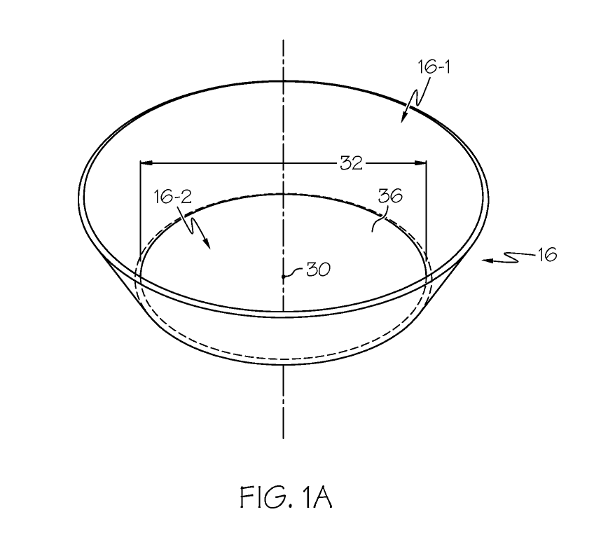

Referring to FIG. 1, an inertial filter 10 may include an air inlet 12 for receiving an inlet flow of air indicated by arrow 14, for example, engine bleed air. The bleed air may be contaminated with various contaminants, such as dusty particles, fly ash, soot and the like. A large portion of the air may be forced to sharply change directions and may be forced to go through louvers 16 as shown by, for example, arrow 20. In some embodiments, this large portion includes at least about 80 percent, typically at least about 90 percent of the inlet flow 14. Contaminants in this large portion of air may be deflected by the louvers 16 and pushed into a central bleed flow of air, indicated by arrow 18, passing through a central portion 36 of the inertial filter 10. A diameter 32 of the central bleed flow 18 may decrease from the air inlet 12 to a central outlet 34 of the inertial filter 10. The central bleed flow 18 may be routed outside of a bleed air circuit (not shown), leaving a clean outlet flow 22 to continue in its original path. A central partition 30 may be disposed centrally along an airflow axis of the inertial filter 10. The airflow axis may be defined by the cross-sectional view of the central partition 30, as shown in FIG. 1.

Referring to FIGS. 1 and 1A, the louvers 16 may be conical shaped with a large opening 16-1 and a small opening 16-2. As air passes through the louvers 16 in the inertial filter 10, the air may strike louver 16 near the small opening 16-2 (due to the immediately upstream louver having a larger small opening 16-2) and pass along the surface of the louver 16 (in between adjacent louvers) towards the large opening 16-1 and out of the louvers 16.

The inertial filter 10 may have a low flow resistance and its efficiency can be optimized by judiciously selecting a louver number (for example, the number of louvers per inch) which may be dependent on a louver spacing 24, a louver angle 26, and a louver length 28. The louver spacing 24 may be from about 0.5 to about 5 mm. The louver angle 26 may be from about 10 to about 90 degrees as measured from a center line of the incoming air flow. The louver length 28 may be from about 5 to about 40 mm. The louvers 16 may have a thickness from about 0.5 mm to about 2 mm. The bleed flow and the velocity of the inlet flow 14 may also be important for determining the efficiency of the inertial filter 10. In some embodiments, the bleed flow may be from about 0.5 to about 3.0 kg/s and the inlet flow velocity may be from about 5 to about 50 m/s.

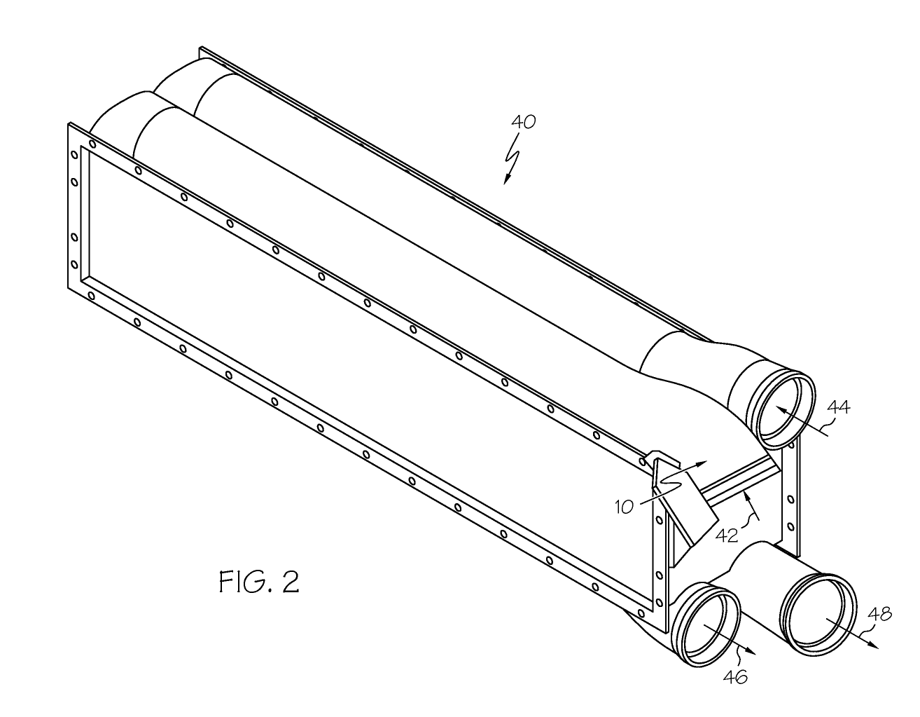

Referring also now to FIG. 2, the inertial filter 10 may be used in a heat exchanger 40. The heat exchanger 40 may be, for example, an ECS heat exchanger or a heat exchanger precooler in an aircraft application. The heat exchanger 40 may include a primary bleed air inlet 42, a main bleed air inlet 44, a primary bleed air outlet 46 and a main bleed air outlet 48. In some embodiments, the inertial filter 10 may be installed inside the primary bleed air inlet 42 as an integral part of the heat exchanger 40. In other embodiments, the inertial filter 10 may be a stand-alone device placed inline with a bleed air flow, for example, immediately upstream of the heat exchanger 40.

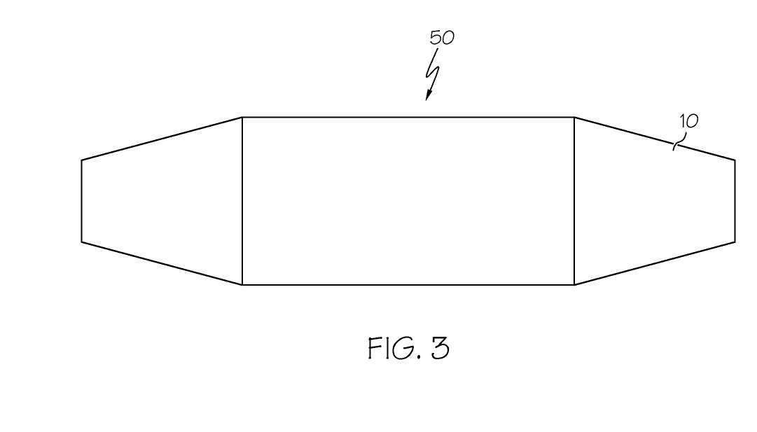

Referring now to FIG. 3, the inertial filter 10 may be installed immediately downstream of a bleed air ozone converter 50. In some embodiments, the inertial filter 10 may be installed as an integral part of the bleed air ozone converter 50. In other embodiments, the inertial filter 10 may be a stand-alone device placed inline with a bleed air flow, for example, immediately downstream of the bleed air ozone converter 50.

While the above description discusses the use of the inertial filter 10 in bleed air purification applications, such as with a heat exchanger 40 or with a bleed air ozone converter 50, the inertial filter 10 may be used in other applications where a purified air stream may be desirable. For example, the inertial filter 10 may be used to purify a bearing cooling air flow, an airflow to air cycle machines (AGMs), an air flow to bus banks and the like.

It should be understood, of course, that the foregoing relates to exemplary embodiments of the invention and that modifications may be made without departing from the spirit and scope of the invention as set forth in the following claims.

What is claimed is:

1. An inertial filter for purifying an air flow, the inertial filter comprising:
an air inlet adapted to receive the air flow;
a plurality of louvers adapted to change a direction of a first air flow passing through the air inlet; and
a central portion of the inertial filter configured to allow a second air flow to pass through with its flow direction unchanged by the louvers, wherein:
the first air flow contains less contaminants compared to the second air flow; and
a diameter of the central portion of the inertial filter decreases from the air inlet to a central outlet of the inertial filter.

2. The inertial filter of claim 1, wherein the louvers form a louver angle with an airflow axis of the inertial filter between a 10 degree angle and a 90 degree angle, as measured from a center line of the airflow axis

3. The inertial filter of claim 1, wherein the louvers are spaced apart from each other a distance from about 0.5 mm to 5 mm.

4. The inertial filter of claim 1, wherein the louvers have a thickness from about 0.5 mm to about 2 mm.

5. The inertial filter of claim 1, further comprising a central partition disposed centrally through small openings between the louvers.

6. The inertial filter of claim 1, wherein the second air flow is expelled from the air flow through the inertial filter.

7. The inertial filter of claim 1, wherein the first air flow is a purified air flow delivered to a downstream component.

8. The inertial filter of claim 7, wherein the downstream component is a heat exchanger.

9. The inertial filter of claim 7, wherein the downstream component is an environmental control system.

10. An environmental control system heat exchanger comprising:
at least one heat exchanger air inlet;
at least one heat exchanger air outlet; and
an inertial filter installed within at least one of the at least one heat exchanger air inlet, the inertial filter including:
an air inlet adapted to receive the air flow;
a plurality of louvers adapted to change a direction of a first air flow passing through the air inlet; and
a central portion of the inertial filter configured to allow a scavenged air flow to pass through with its flow direction unchanged by the louvers, wherein
the first air flow contains less contaminants compared to the scavenged air flow; and
a diameter of the central portion of the inertial filter decreases from the air inlet to a central outlet of the inertial filter.

11. The environmental control system of claim 10, wherein the inertial filter is integral with the heat exchanger.

12. The environmental control system of claim 10, wherein the at least one heat exchanger air inlet includes a primary bleed air inlet and a main bleed air inlet and the inertial filter is disposed within the primary bleed air inlet.

13. The environmental control system of claim 10, wherein:
the louvers form a louver angle with an airflow axis of the inertial filter between 10 and 90 degrees;
the louvers are spaced apart from each other a distance from about 0.5 mm to about 5 mm; and
the louvers have a louver thickness from about 0.5 mm to about 2 mm.

14. The environmental control system of claim 10, further comprising a central partition disposed centrally through small openings of the louvers.

15. The environmental control system of claim 10, wherein the scavenged air flow is expelled from the heat exchanger.

16. A bleed air ozone converter comprising:
an air inlet adapted to deliver an air flow to an ozone converter;
an air outlet adapted to receive the air flow from the ozone converter; and
an inertial filter inside the air outlet, the inertial filter including:
an inertial filter air inlet adapted to receive the air flow;
a plurality of louvers adapted to change a direction of a first air flow passing through the inertial filter air inlet; and
a central portion of the inertial filter configured to allow a scavenged air flow to pass through with its flow direction unchanged by the louvers, wherein
the first air flow contains less contaminants compared to the scavenged air flow; and
a diameter of the central portion of the inertial filter decreases from the inertial filter air inlet to a central outlet of the inertial filter.

17. The bleed air ozone converter of claim 16, wherein the inertial filter is integral with the bleed air ozone converter.

18. The bleed air ozone converter of claim 16, wherein:
the louvers form a louver angle with an airflow axis of the inertial filter between 10 and 90 degrees;
the louvers are spaced apart from each other a distance from about 0.5 mm to about 5 mm; and
the louvers have a louver thickness from about 0.5 mm to about 2 mm.

19. The bleed air ozone converter of claim 16, further comprising a central partition disposed centrally through small openings of the louvers.

20. The bleed air ozone converter of claim 10, wherein the scavenged air flow is expelled from the air flow.
